(19) United States
(12) Patent Application Publication
(10) Pub. No.: US 2025/0040545 A1
(43) Pub. Date: Feb. 6, 2025

(54) USE OF SYNERGISTIC COMPOSITIONS BASED ON ZOXAMIDE AND CYFLUFENAMID AS FUNGICIDES IN THE AGRONOMIC FIELD

(71) Applicant: Gowan Crop Protection Limited, Harpenden (GB)

(72) Inventors: Kartik ANAND, Yuma, AZ (US); Chad Douglas DYER, Olathe, KS (US); Marilena GUSMEROLI, Monza, (MB) (IT); Giovanni VENTURINI, Cassano d'Adda (MI) (IT); Jessica VILLATA, Cameri (NO) (IT)

(21) Appl. No.: 18/230,488

(22) Filed: Aug. 4, 2023

(51) Int. Cl. A01N 37/52; A01N 37/20; A01P 3/00

(52) U.S. Cl. CPC A01N 37/52; A01N 37/20; A01P 3/00

(57) ABSTRACT

A method for the control of phytopathogenic fungi in agricultural crops using a synergistic fungicidal composition comprising Zoxamide (A) and Cyflufenamid (B) on plants or on the soil in which said plants grow.

### FIELD OF THE INVENTION

The present invention relates to the use of synergistic compositions based on Zoxamide and Cyflufenamid for the control and/or treatment of phytopathogenic fungi in the agronomic field.

### BACKGROUND OF THE INVENTION

More specifically, said synergistic compositions can be used for the control and/or treatment of grey mildew on vines caused by Botrytis cinerea, white rot on lettuces and many other plants such as soybeans, sunflowers, rapeseed, tomatoes, leguminous plants, cucurbits (such as, for example, pumpkins, courgettes, cucumbers, melons, watermelons, etc.) caused by Sclerotinia spp. and apple-tree scab caused by Venturia inaequalis.

Zoxamide is a well-known foliar fungicide, with a preventive action, belonging to the benzamide family, discovered and developed by Rohm and Haas. The product is particularly effective against grape downy mildew (Plasmopara viticola), potato and tomato downy mildew (Phytophthora infestans) and cucumber downy mildew (Pseudoperonospora cubensis).

Cyflufenamid is also a well-known fungicide with a preventive action, belonging to the chemical class of starches, discovered and developed by the Japanese company Nippon Soda.

It is particularly active against powdery mildew, such as, for example, in apple trees (Podosphaera leucotricha), vines (Erysiphe necator), cucurbits (Golovinomyces cichoracearum and Podosphaera xanthii) and solanaceae (Leveillula taurica).

It is known that in the agronomic field, it is particularly advantageous to identify and use mixtures of products which exert a synergistic activity with each other in order to be able to broaden the characteristic spectrum of action of the single active ingredients, reduce the agronomic doses of application compared to the doses of use of the single active ingredients (and therefore lower the costs for application of the product) and/or reduce the risk of resistance, an increasingly widespread phenomenon in agriculture, which consists in a reduction in the sensitivity of a pathogen towards a specific active substance.

Chinese patent application CN103999865 claims a synergistic composition of Zoxamide and Cyflufenamid against foliar diseases such as powdery mildew and downy mildew.

### SUMMARY OF THE INVENTION

The Applicant has now identified a new and unexpected fungicidal biological activity of compositions comprising or consisting of Zoxamide and Cyflufenamid with respect to the typical biological activities of the two single active ingredients as it is exerted on different pathogens with respect to those claimed in CN103999865, such as soil fungi and rots which affect the roots and the collar of the plant. The document CN103999865, in fact, demonstrates the activity of mixtures of Zoxamide and Cyflufenamid against cucumber powdery mildew (a disease caused by Golovinomyces cichoracearum and Podosphaera xanthii) and brown spot of turf (caused by Rhizoctonia solani).

More specifically, the Applicant has surprisingly found that compositions comprising or consisting of Zoxamide and Cyflufenamid exert a synergistic action against some phytopathogenic fungi which attack crops of considerable agronomic interest, allowing, in agriculture, the use of said compositions on various crops and against pathogens that are not controlled or poorly controlled by the singles active ingredients with a reduction in the application doses and number of treatments (with consequent cost and time savings).

### DETAILED DESCRIPTION OF THE PREFERRED EMBODIMENT

The present invention therefore relates to the use of a synergistic fungicidal composition comprising or consisting of Zoxamide (A) and Cyflufenamid (B) for the control and/or treatment of phytopathogenic fungi in agricultural crops wherein the weight ratio between component (A) and component (B) ranges from 500:1 to 1:100.

More preferably, in the above composition, the weight ratio between component (A) and component (B) ranges from 100:1 to 1:10.

Said compositions are in fact distinguished by an exceptional synergistic activity in particular on the following phytopathogenic fungi:
Botrytis spp., in particular Botrytis cinerea grey mildew agent of fruit such as berries and drupes, for example strawberries and grapes, vegetables such as lettuces, carrots, onions and cabbages, extensive crops such as rapeseed, forest and ornamental plants:
Sclerotinia spp. mainly Sclerotinia sclerotiorum and S. minor, white rot agents of the stems on vegetables and extensive crops such as rapeseed, sunflowers and soybeans:
Venturia spp. such as Venturia inaequalis, agent of apple-tree scab.

In a preferred embodiment, the synergistic fungicidal composition according to the present invention can therefore be used for the control and/or treatment of phytopathogenic fungi selected from Botrytis spp. (even more preferably Botrytis cinerea), Sclerotinia spp. (even more preferably Sclerotinia minor) and Venturia spp. (even more preferably Venturia inaequalis).

The main crops which can be protected with the compositions according to the present invention comprise cereals (such as wheat, barley, rye, oats, rice, corn, sorghum, etc.), fruit trees (such as apples, pears, plums, peaches, almonds, cherries, bananas, vines, strawberries, raspberries, blackberries, etc.), citrus fruits (such as oranges, lemons, mandarins, grapefruit, etc.), legumes (such as beans, peas, lentils, soybeans, etc.), vegetables (such as spinach, lettuces, asparagus, cabbages, carrots, onions, tomatoes, potatoes, aubergines, peppers, etc.), cucurbits (such as pumpkins, courgettes, cucumbers, melons, watermelons, etc.,), oil plants (such as sunflowers, rapeseed, peanuts, castor-oil plants, coconut, etc.), tobacco, coffee, tea, cocoa, sugar beet, sugar cane, cotton.

The crops which can be protected with the compositions according to the present invention more preferably comprise grapevines (for example for the treatment of grey mildew caused by Botrytis cinerea), lettuces, soybeans, sunflowers, rapeseed, tomatoes, legumes (for example for the treatment of white rot caused by Sclerotinia spp.), pumpkins, courgettes, cucumbers, melons, watermelons and apple trees (e.g., for the treatment of scab caused by Venturia inaequalis).

The synergistic effect of the compositions comprising or consisting of Zoxamide (A) and Cyflufenamid (B), can be objectively assessed by applying the Colby formula (“Weeds”, 1967, 15, pages 20-22):

$${E}_{t} = {E}_{A} + {E}_{B} - ( {E}_{A} \times {E}_{B} ) / 100$$

wherein Eₜ is the percentage of effectiveness expected for the composition containing compounds (A) and (B) at doses d_{A}+d_{B}, E_{A} is the percentage of effectiveness observed for component (A) at doses d_{A}, E_{B} is the percentage of effectiveness observed for component (B) at doses d_{B}.

When the effectiveness observed (E_{A+B}) for the mixture (A)+(B) is higher than the expected effectiveness according to the Colby formula (E_{A+B}/Eₜ>1), there is a synergistic effect.

Table 1 indicates specific examples of mixtures consisting of Zoxamide (A) and Cyflufenamid (B), particularly interesting for their synergistic activity.

TABLE 1

| Composition | | |
|---|---|---|
| nr. | Compounds | Ratio |
| 1 | Zoxamide:Cyflufenamid | 1:1 |
| 2 | Zoxamide:Cyflufenamid | 2:1 |
| 3 | Zoxamide:Cyflufenamid | 10:1 |
| 4 | Zoxamide:Cyflufenamid | 20:1 |
| 5 | Zoxamide:Cyflufenamid | 50:1 |
| 6 | Zoxamide:Cyflufenamid | 100:1 |
| 7 | Zoxamide:Cyflufenamid | 500:1 |
| 8 | Zoxamide:Cyflufenamid | 1:5 |
| 9 | Zoxamide:Cyflufenamid | 1:10 |
| 10 | Zoxamide:Cyflufenamid | 1:100 |

The fungicidal use of synergistic compositions comprising or consisting of Zoxamide (A) and Cyflufenamid (B), object of the present invention, can be of the preventive or eradicating type and exhibits zero phytotoxicity on the crops treated.

The application of these synergistic compositions can take place on any part of the plant, for example on the leaves, stems, branches and fruit, or in the soil where the plant grows.

The present invention therefore also relates to a method for the control of phytopathogenic fungi in agricultural crops which comprises applying effective and non-phytotoxic doses of synergistic compositions comprising or consisting of Zoxamide (A) and Cyflufenamid (B) on any part of the plants to be protected or on the soil, wherein the weight ratios of (A) with respect to (B) range from 500:1 to 1:100, more preferably from 100:1 to 1:10.

The total weight content of components (A) and (B) in said synergistic fungicidal composition can vary within a wide range: in general ranging from 1% to 90% by weight with respect to the total weight of the composition, preferably from 5 to 50% by weight with respect to the total weight of the composition.

The present invention therefore further relates to a method for the control of phytopathogenic fungi in agricultural crops, which comprises applying effective doses of a synergistic fungicidal composition comprising or consisting of Zoxamide (A) and Cyflufenamid (B).

The quantity of Zoxamide (A) and Cyflufenamid (B), as also the weight ratio of said components (A) and (B) to be applied for obtaining the desired effect, can vary according to various factors such as, for example, the crop to be preserved, the type of pathogen, the degree of infection, the climatic conditions, the method of application, the formulation adopted.

Total quantities of Zoxamide (A) and Cyflufenamid (B) ranging from 10 g to 5 kg per hectare of agricultural crop generally provide sufficient control.

For practical uses in agriculture, it is often preferable to use fungicidal compositions containing Zoxamide (A) and Cyflufenamid (B) and suitable excipients.

The present invention also relates to the use of fungicidal compositions comprising a synergistic fungicidal composition comprising or consisting of Zoxamide (A) and Cyflufenamid (B), a solid or liquid solvent and/or diluent and possibly a surfactant.

The above fungicidal compositions can be in the form of dry powders, wettable powders, emulsifiable concentrates, emulsions, microemulsions, suspo-emulsions and suspensions in water or in oil, granules, water-dispersible granules, solutions, suspensions, etc.: the choice of the type of composition will depend on the specific use.

The fungicidal compositions are prepared in a known manner, for example by diluting or dissolving components (A) and (B) with a solvent medium and/or a solid or liquid diluent, optionally in the presence of surfactants.

The following can be used, for example, as solid diluents, or carriers: silica, kaolin, bentonite, talc, diatomaceous earth, dolomite, calcium carbonate, magnesia, gypsum, clays, synthetic silicates, attapulgite, sepiolite and mixtures thereof.

The following can be used, for example, as solvents or liquid diluents, in addition to water, aromatic organic solvents (xylenes or mixtures of alkylbenzenes, chlorobenzene, etc.), paraffins (petroleum fractions), alcohols (methanol, propanol, butanol, octanol, glycerine, etc.), esters (ethyl acetate, diisobutyl acetate, alkyl carbonates, alkyl esters of adipic acid, alkyl esters of glutaric acid, alkyl esters of succinic acid, alkyl esters of lactic acid, etc.), vegetable oils (rapeseed oil, sunflower oil, soybean oil, castor oil, corn oil, peanut oil, and their alkyl esters), ketones (cyclohexanone, acetone, acetophenone, isophorone, ethylamilketone, etc.), amides (N,N-dimethylalkylamides, N-methylpyrrolidone, etc.), sulfoxides and sulfones (dimethyl sulfoxide, dimethyl sulfone, etc.), and mixtures thereof.

Propellant gases such as butane, propane, halogenated hydrocarbons, nitrogen or carbon dioxide can be used as liquefied diluents or liquefied substances which gasify at room temperature and pressure.

The following can be used as surfactants: sodium, calcium, potassium, triethylamine or triethanolamine salts of alkylnaphthalenesulfonates, polynaphthalenesulfonates, alkylsulfonates, arylsulfonates, alkylarylsulfonates, polycarboxylates, sulfosuccinates, alkylsulfosuccinates, ligninsulfonates, alkylsulfates; and polyethoxylated fatty alcohols, polyethoxylated alkylphenols, polyethoxylated or polypropoxy-polyethoxylated arylphenols or polyethoxylated, polypropoxy-polyethoxylated sorbitol esters (block polymers) can also be used.

The fungicidal compositions can also contain special additives for particular purposes, for example antifreezes such as propylene glycol, or tackifiers such as Arabic gum, polyvinyl alcohol, polyvinylpyrrolidone, dispersants, for example lignin and its salts, cellulose derivatives or alginates, or stabilizers, for example antioxidants or ultraviolet absorbers.

Said fungicidal compositions can further comprise at least one active ingredient compatible with components (A) and (B) selected from: fungicides other than components (A) and (B), insecticides, plant-growth regulators, antibiotics, herbicides, fertilizers and/or mixtures thereof.

The concentration of the active substances (A) and (B) in the above compositions can vary within a wide range and depends on various factors. It varies according to the applications for which said compositions are intended, the environmental conditions and the type of formulation adopted. In general, the concentration of the active substances (A) and (B) varies from 1 to 90% by weight with respect to the total weight of the composition, preferably from 5 to 50% by weight.

The following examples are provided hereunder in order to better illustrate the invention and should be considered as being illustrative and non-limiting of the same.

### Example 1

Determination of the In Vitro Antifungal Synergistic Activity of Compositions of Zoxamide (A) and Cyflufenamid (B) Against Botrytis cinerea, Sclerotinia Minor and Venturia inaequalis.

Compositions consisting of the active ingredients Zoxamide (A) and Cyflufenamid (B) in different weight ratios were tested to evaluate their in vitro synergistic antifungal activity against the following phytopathogenic fungi: Botrytis cinerea, Sclerotinia minor and Venturia inaequalis by comparing them with the single active ingredients (A) and (B).

The strains in pure culture are kept and stored at 4° C. in a refrigerator on potato dextrose agar (PDA) nutrient substrates. The fungal inoculum was prepared (which, depending on the species of the pathogen, could be a suspension of conidia or a mycelial homogenate) for carrying out the synergy assays.

For the strains not easily sporulating in vitro, i.e. Sclerotinia minor and Venturia inaequalis, six to eight pieces of mycelium, taken from actively growing cultures, are transferred into a grinding egg containing 6 ml of double-concentration potato dextrose broth (PDB). and some metal balls. The suspension is homogenized with a Pulverisette 23 mini-mill (Fritsch GmbH).

For the in vitro sporulating strain, i.e. Botrytis cinerea, the conidic suspension was prepared starting from a culture grown on PDA after 4-5 days of incubation in a thermostat at 24° C. to stimulate its sporulation. The conidia were collected in 1 mL of double-concentration PDB and counted under a microscope with a counting chamber to obtain a final inoculum of 4×10⁴ conidia/mL.

In the compositions tested, the weight ratios of Zoxamide (A) with respect to Cyflufenamid (B) range from 500:1 to 1:100. For both molecules tested, a stock solution in dimethyl sulfoxide (DMSO) at 160,000 mg/l was prepared which was then serially diluted in sterile demineralized water to obtain the solutions to be tested at concentrations double with respect to the final doses. More specifically, the compositions of the two fungicide molecules (A) and (B) were tested following a checkerboard matrix in order to have, in this way, all possible combinations of the two fungicides within the weight ratios described above.

Table 2 indicates an example of a checkerboard scheme with the matrix of some possible dose combinations of the two fungicides Zoxamide (A) and Cyflufenamid (B).

TABLE 2

| | | | | | | | |
|---|---|---|---|---|---|---|---|
| Zoxamide (A) | 100 | 100 | 100 | 100 | 100 | 100 | compositions |
| (mg/l) | | | | | | | (mg/l) |
| Cyflufenamid/ | 100 | 50 | 10 | 5 | 1 | 0.1 | |
| B) (mg/l) | | | | | | | |
| Zoxamide | 50 | 50 | 50 | 50 | 50 | 50 | |
| (A) (mg/l) | | | | | | | |
| Cyflufenamid | 100 | 50 | 10 | 5 | 1 | 0.1 | |
| (B) (mg/l) | | | | | | | |
| Zoxamide (A) | 10 | 10 | 10 | 10 | 10 | 10 | |
| (mg/l) | | | | | | | |
| Cyflufenamid | 100 | 50 | 10 | 5 | 1 | 0.1 | |
| (B) (mg/l) | | | | | | | |
| Zoxamide (A) | 5 | 5 | 5 | 5 | 5 | 5 | |
| (mg/l) | | | | | | | |
| Cyflufenamid | 100 | 50 | 10 | 5 | 1 | 0.1 | |
| (B) (mg/l)) | | | | | | | |
| Zoxamide (A) | 1 | 1 | 1 | 1 | 1 | 1 | |
| (mg/l) | | | | | | | |
| Cyflufenamid | 100 | 50 | 10 | 5 | 1 | 0.1 | |
| (B) (mg/l) | | | | | | | |

Synergy assays were performed in 96-well plates: 50 μl of inoculum were mixed with 50 μl of solution of the compositions consisting of the two active molecules (A) and (B) in each well using the Eppendorf Multipette® System E3 serial dispenser.

Three wells were used as replicates for each concentration/active ingredient composition.

All pathogen strains were grown in untreated control wells containing 50 μl of fungal suspension and 50 μl of sterile demineralized water. The inoculated multi-well plates are incubated at 22° C. for 72 hours or 96 or 120 depending on the type of pathogen.

The sensitivity to the molecules was evaluated as growth inhibition of the fungus and measured in terms of absorbance immediately before and after the incubation period.

The absorbance was measured for each well using the Infinite® F50 Absorbance Reader (Tecan Group Ltd) spectrophotometer at 405 nm (for mycelial inoculums) and at 492 nm (for conidic inoculums).

For each strain, the percentage of growth inhibition (GIP) caused by each of the active-ingredient concentrations was calculated using the following formula:

$$GIP = \frac{⌊ {( {A}_{t 72 - 120} - {A}_{t 0} )}_{untreated} ⌋ - ⌊ {( {A}_{t 72 - 120} - {A}_{t 0} )}_{treated} ⌋}{{( {A}_{t 72 - 120} - {A}_{t 0} )}_{untreated}} \times 100$$

wherein At₇₂₋₁₂₀ and At₀ are respectively the absorbances of the treated well and of the untreated control measured at the end and at the beginning of the incubation period. GIP data were used for calculating the potential synergistic effect of the compositions tested using the formula proposed by Colby (1967):

$${GIP}_{t} = {GIP}_{a} + {GIP}_{b} - ( {GIP}_{a} \times {GIP}_{b} / 100 )$$

wherein:
GIPₜ=GIP expected of the active molecule A and B tested at dose p for molecule
A and dose q for molecule B:
GIPₐ=GIP expected from the molecule A tested at dose p;
GIP_{b}=GIP expected from the molecule B tested at dose q.

The synergistic effect of the two molecules is indicated when the effectiveness of the mixed combination of A+B (GIPₐ+GIP_{b}), is higher than the expected effectiveness calculated with the Colby equation (GIP_{a+b}/GIPₜ>1), as described in literature in Colby, S. R. (1967): “Calculating synergistic and antagonistic responses of herbicide combinations”, Weeds, 15 (1), pages 20-22.

In particular, an analysis was effected of the compositions Nr. 1-10 indicated in Table 1. Said compositions are in fact representative of the weight ratios between the two components (A) and (B) previously indicated.

Table 3 indicates the results obtained by carrying out the test described against Botrytis cinerea with compositions Nr. 1, 2, 3, 4, 5, 6, 7, 8, 9 and 10, with the reference composition (100 mg/l of Zoxamide (A) and 0.1 mg/l of Cyflufenamid (B)) and with Zoxamide (A) and Cyflufenamid (B) as single active ingredients, expressed as growth-inhibition percentage (GIP) and calculated according to the Colby equation. As can be seen from the data in Table 3, the synergistic effect between the two components (A) and (B) with respect to Botrytis cinerea is observed in all compositions Nr. 1-10.

TABLE 3

| | | | Effect | Synergistic |
|---|---|---|---|---|
| | | | Mix | ratio |
| | | | tested | according |
| | | Effect A, | (GIP | to Colby |
| | Dose | Effect B | a + | (GIP a + |
| Compound | (mg/l) | (GIP) | b) | b/GIPₜ) |
| Zoxamide (A) | 100 | 56.9 | — | |
| Cyflufenamid (B) | 100 | 60.2 | — | |
| Composition nr. 1 (A + B) | 100 + 100 | GIPₜ 82.8 | 87.8 | 1.06 |
| Zoxamide (A) | 100 | 56.9 | — | |
| Cyflufenamid (B) | 50 | 49.4 | — | |
| Composition nr. 2 (A + B) | 100 + 50 | GIPₜ 78.2 | 93.2 | 1.21 |
| Zoxamide (A) | 10 | 31.2 | — | |
| Cyflufenamid (B) | 1 | 4.3 | — | |
| Composition nr. 3 (A + B) | 10 + 1 | GIPₜ 34.2 | 39.6 | 1.16 |
| Zoxamide (A) | 100 | 56.9 | — | |
| Cyflufenamid (B) | 5 | 10.6 | — | |
| Composition nr. 4 (A + B) | 100 + 5 | GIPₜ 61.5 | 62.9 | 1.02 |
| Zoxamide (A) | 50 | 47.3 | — | |
| Cyflufenamid (B) | 1 | 4.3 | — | |
| Composition nr. 5 (A + B) | 50 + 1 | GIPₜ 49.5 | 51.7 | 1.05 |
| Zoxamide (A) | 100 | 56.9 | — | |
| Cyflufenamid (B) | 1 | 4.3 | — | |
| Composition nr. 6 (A + B) | 100 + 1 | GIPₜ 58.7 | 77.5 | 1.32 |
| Zoxamide (A) | 50 | 47.3 | — | |
| Cyflufenamid (B) | 0.1 | 1.7 | — | |
| Composition nr. 7 (A + B) | 50 + 0.1 | GIPₜ 48.2 | 52.1 | 1.08 |
| Zoxamide (A) | 10 | 31.2 | — | |
| Cyflufenamid (B) | 50 | 49.4 | — | |
| Composition nr. 8 (A + B) | 10 + 50 | GIPₜ 65.2 | 72.4 | 1.11 |
| Zoxamide (A) | 10 | 31.2 | — | |
| Cyflufenamid (B) | 100 | 60.2 | — | |
| Composition nr. 9 (A + B) | 10 + 100 | GIPₜ 72.6 | 82.1 | 1.15 |
| Zoxamide (A) | 1 | 5.6 | — | |
| Cyflufenamid (B) | 100 | 60.2 | — | |
| Composition nr. 10 (A + B) | 1 + 100 | GIPₜ 62.4 | 63.1 | 1.01 |
| Zoxamide (A) | 100 | 56.9 | — | |
| Cyflufenamid (B) | 0.1 | 1.7 | — | |
| Reference composition | 100 + 0.1 | GIPₜ 57.6 | 49.5 | 0.86 |
| (A + B) | | | | |

Table 4 indicates the results obtained by carrying out the test described against Sclerotinia minor with compositions Nr. 1, 2, 3, 4, 5, 6, 7, 8, 9 and 10, with the reference composition (100 mg/l of Zoxamide (A) and 0.1 mg/l of Cyflufenamid (B)) and with Zoxamide (A) and Cyflufenamid (B) as single active ingredients, expressed as growth-inhibition percentage (GIP) and calculated according to the Colby equation. As can be seen from the data in Table 4, the synergistic effect between the two components (A) and (B) with respect to Sclerotinia minor is observed in all compositions Nr. 1-10.

TABLE 4

| | | | Effect | Synergistic |
|---|---|---|---|---|
| | | | Mix | ratio |
| | | | tested | according |
| | | Effect A, | (GIP | to Colby |
| | Dose | Effect B | a + | (GIP a + |
| Compound | (mg/l) | (GIP) | b) | b/GIPₜ |
| Zoxamide (A) | 10 | 37.6 | — | |
| Cyflufenamid (B) | 10 | 23.4 | — | |
| Composition nr. 1 (A + B) | 10 + 10 | GIPₜ 52.2 | 93.2 | 1.78 |
| Zoxamide (A) | 10 | 37.6 | — | |
| Cyflufenamid (B) | 5 | 17.8 | — | |
| Composition nr. 2 (A + B) | 10 + 5 | GIPₜ 48.7 | 67.1 | 1.38 |
| Zoxamide (A) | 10 | 37.6 | — | |
| Cyflufenamid (B) | 1 | 10.2 | — | |
| Composition nr. 3 (A + B) | 10 + 1 | GIPₜ 43.9 | 44.4 | 1.02 |
| Zoxamide (A) | 100 | 70.3 | — | |
| Cyflufenamid (B) | 5 | 17.8 | — | |
| Composition nr. 4 (A + B) | 100 + 5 | GIPₜ 75.6 | 77.8 | 1.03 |
| Zoxamide (A) | 50 | 58.2 | — | |
| Cyflufenamid (B) | 1 | 10.2 | — | |
| Composition nr. 5 (A + B) | 50 + 1 | GIPₜ 62.5 | 66.8 | 1.07 |
| Zoxamide (A) | 10 | 37.6 | — | |
| Cyflufenamid (B) | 0.1 | 3.7 | — | |
| Composition nr. 6 (A + B) | 10 + 0.1 | GIPₜ 39.9 | 43.1 | 1.08 |
| Zoxamide (A) | 1 | 29.1 | — | |
| Cyflufenamid (B) | 5 | 17.8 | — | |
| Composition nr. 7 (A + B) | 1 + 5 | GIPₜ 48.8 | 69.5 | 1.42 |
| Zoxamide (A) | 1 | 29.1 | — | |
| Cyflufenamid (B) | 10 | 23.4 | — | |
| Composition nr. (A + B) | 1 + 10 | GIPₜ 50.5 | 79.2 | 1.69 |
| Zoxamide (A) | 50 | 58.2 | — | |
| Cyflufenamid (B) | 0.1 | 3.7 | — | |
| Composition nr. 9 (A + B) | 50 + 0.1 | GIPₜ 59.7 | 60.9 | 1.02 |
| Zoxamide (A) | 0.1 | 2.5 | — | |
| Cyflufenamid (B) | 10 | 23.4 | — | |
| Composition nr. 10 (A + B) | 0.1 + 10 | GIPₜ 25.3 | 27.8 | 1.10 |
| Zoxamide (A) | 100 | 70.3 | — | |
| Cyflufenamid (B) | 0.1 | 3.7 | — | |
| Reference composition | 100 + 0.1 | GIPₜ 71.4 | 57.8 | 0.81 |
| (A + B) | | | | |

Table 5 indicates the results obtained by carrying out the test described against Venturia inaequalis with compositions Nr. 1, 2, 3, 4, 5, 6, 7, 8, 9 and 10, with the reference composition (100 mg/l of Zoxamide (A) and 0.1 mg/l of Cyflufenamid (B)) and with Zoxamide (A) and Cyflufenamid (B) as single active ingredients, expressed as growth-inhibition percentage (GIP) and calculated according to the Colby equation. As can be seen from the data in Table 5, the synergistic effect between the two components (A) and (B) with respect to Venturia inaequalis is observed in all compositions Nr. 1-10.

TABLE 5

| | | | | Synergistic |
|---|---|---|---|---|
| | | | Effect | ratio |
| | | | Mix | according |
| | | Effect A, | tested | to Colby |
| | Dose | Effect B | (GIP | (GIP a + b/ |
| Compound | (mg/l) | (GIP) | a + b) | GIPₜ |
| Zoxamide (A) | 1 | 78.0 | — | |
| Cyflufenamid (B) | 1 | 5.5 | — | |
| Composition nr. 1 (A + B) | 1 + 1 | GIPₜ 79.2 | 95.0 | 1.19 |
| Zoxamide (A) | 100 | 84.5 | — | |
| Cyflufenamid (B) | 50 | 15.2 | — | |
| Composition nr. 2 (A + B) | 100 + 50 | GIPₜ 86.8 | 87.8 | 1.01 |
| Zoxamide (A) | 100 | 84.5 | — | |
| Cyflufenamid (B) | 10 | 12.7 | — | |
| Composition nr. 3 (A + B) | 100 + 10 | GIPₜ 86.4 | 94.3 | 1.09 |
| Zoxamide (A) | 100 | 84.5 | — | |
| Cyflufenamid (B) | 5 | 10.3 | — | |
| Composition nr. 4 (A + B) | 100 + 5 | GIPₜ 86.1 | 91.3 | 1.06 |
| Zoxamide (A) | 5 | 78.8 | — | |
| Cyflufenamid (B) | 0.1 | 1.2 | — | |
| Composition nr. 5 (A + B) | 5 + 0.1 | GIPₜ 79.1 | 83.0 | 1.05 |
| Zoxamide (A) | 100 | 84.0 | — | |
| Cyflufenamid (B) | 1 | 5.5 | — | |
| Composition nr. 6 (A + B) | 100 + 1 | GIPₜ 84.8 | 96.0 | 1.13 |
| Zoxamide (A) | 50 | 80.1 | — | |
| Cyflufenamid (B) | 0.1 | 1.2 | — | |
| Composition nr. 7 (A + B) | 50 + 0.1 | GIPₜ 80.3 | 81.1 | 1.01 |
| Zoxamide (A) | 10 | 80.0 | — | |
| Cyflufenamid (B) | 50 | 12.7 | — | |
| Composition nr. 8 (A + B) | 10 + 50 | GIPₜ 82.5 | 86.7 | 1.09 |
| Zoxamide (A) | 10 | 80.0 | — | |
| Cyflufenamid (B) | 100 | 18.3 | — | |
| Composition nr. 9 (A + B) | 10 + 100 | GIPₜ 83.6 | 87.8 | 1.05 |
| Zoxamide (A) | 1 | 78.0 | — | |
| Cyflufenamid (B) | 100 | 18.0 | — | |
| Composition nr. 10 (A + B) | 1 + 100 | GIPₜ 81.9 | 88.0 | 1.08 |
| Zoxamide (A) | 100 | 84.5 | — | |
| Cyflufenamid (B) | 0.1 | 1.2 | — | |
| Reference composition | 100 + 0.1 | GIPₜ 84.6 | 63.7 | 0.75 |
| (A + B) | | | | |

1. A method for the control of phytopathogenic fungi in agricultural crops comprising applying at least one effective and non-phytotoxic dose of a synergistic fungicidal composition comprising Zoxamide (A) and Cyflufenamid (B) on any part of the plant and/or plants to be protected or on the soil in which said plants grow, wherein the weight ratio of (A) with respect to (B) ranges from 500:1 to 1:100.

2. A method according to claim 1, wherein the weight ratio of (A) with respect to (B) ranges from 100:1 to 1:10.

3. A method according to claim 1, wherein said pathogenic fungi are selected from the group consisting of Botrytis spp., Sclerotinia spp. and Venturia spp.

4. A method according to claim 1, wherein said pathogenic fungi are selected from the group consisting of Botrytis cinerea, Sclerotinia minor and Venturia inaequalis.

5. A method according to claim 1, wherein said synergistic fungicidal composition further comprises a solid or liquid solvent and/or diluent and optionally a surfactant.

6. A method according to claim 1, wherein said synergistic fungicidal composition further comprises at least one active ingredient compatible with components (A) and (B) selected from the group consisting of: fungicides other than components (A) and (B), insecticides, plant-growth regulators, antibiotics, herbicides, fertilizers and/or mixtures thereof.

7. A method according to claim 1, wherein the agricultural crops are selected from the group consisting of: cereals, fruit trees, citrus fruits, legumes, vegetables, cucurbits, oil plants, tobacco, coffee, tea, cocoa, sugar beet, sugar cane, and cotton.

8. A method according to claim 1, wherein the agricultural crops are selected from the group consisting of: wheat, barley, rye, oats, rice, com, apples, pears, plums, peaches, almonds, cherries, bananas, vines, strawberries, raspberries, blackberries, oranges, lemons, mandarins, grapefruit, beans, peas, lentils, soybeans, spinach, lettuces, asparagus, cabbage, carrots, onions, tomatoes, potatoes, aubergines, peppers, pumpkins, courgettes, cucumbers, melons, watermelons, sunflowers, rapeseed, peanuts, castor-oil plants, and coconut.

9. A method according to claim 1, wherein the agricultural crops are selected from the group consisting of: vines, lettuces, soybeans, sunflowers, rapeseed, tomatoes, legumes, pumpkins, courgettes, cucumbers, melons, watermelons and apple trees.

10. A method according to claim 2, wherein said pathogenic fungi are selected from the group consisting of Botrytis spp., Sclerotinia spp. and Venturia spp.

11. A method according to claim 2, wherein said pathogenic fungi are selected from the group consisting of Botrytis cinerea, Sclerotinia minor and Venturia inaequalis.

12. A method according to claim 2, wherein said synergistic fungicidal composition further comprises a solid or liquid solvent and/or diluent and optionally a surfactant.

13. A method according to claim 2, wherein said synergistic fungicidal composition further comprises at least one active ingredient compatible with components (A) and (B) selected from the group consisting of: fungicides other than components (A) and (B), insecticides, plant-growth regulators, antibiotics, herbicides, fertilizers and/or mixtures thereof.

14. A method according to claim 2, wherein the agricultural crops are selected from the group consisting of: cereals, fruit trees, citrus fruits, legumes, vegetables, cucurbits, oil plants, tobacco, coffee, tea, cocoa, sugar beet, sugar cane, and cotton.

15. A method according to claim 2, wherein the agricultural crops are selected from the group consisting of: wheat, barley, rye, oats, rice, corn, apples, pears, plums, peaches, almonds, cherries, bananas, vines, strawberries, raspberries, blackberries, oranges, lemons, mandarins, grapefruit, beans, peas, lentils, soybeans, spinach, lettuces, asparagus, cabbage, carrots, onions, tomatoes, potatoes, aubergines, peppers, pumpkins, courgettes, cucumbers, melons, watermelons, sunflowers, rapeseed, peanuts, castor-oil plants, and coconut.

16. A method according to claim 2, wherein the agricultural crops are selected from the group consisting of: vines, lettuces, soybeans, sunflowers, rapeseed, tomatoes, legumes, pumpkins, courgettes, cucumbers, melons, watermelons and apple trees.

17. A method according to claim 3, wherein the agricultural crops are selected from the group consisting of: cereals, fruit trees, citrus fruits, legumes, vegetables, cucurbits, oil plants, tobacco, coffee, tea, cocoa, sugar beet, sugar cane, and cotton.

18. A method according to claim 4, wherein the agricultural crops are selected from the group consisting of: cereals, fruit trees, citrus fruits, legumes, vegetables, cucurbits, oil plants, tobacco, coffee, tea, cocoa, sugar beet, sugar cane, and cotton.
